(19) United States
(12) Patent Application Publication
(10) Pub. No.: US 2016/0177051 A1
(43) Pub. Date: Jun. 23, 2016

(54) Novel fire-resistant compositions for the high temperature plastic materials

(71) Applicant: JJI Technologies, LLC, Painesville, OH (US)

(72) Inventors: Anton Constantinescu, Mentor, OH (US); David Diefenthal, Painesville, OH (US)

(73) Assignee: JJI Technologies, LLC, Painesville, OH (US)

(21) Appl. No.: 14/998,124

(22) Filed: Dec. 23, 2015

Related U.S. Application Data
(60) Provisional application No. 62/096,210, filed on Dec. 23, 2014.

(51) Int. Cl. C08K 3/32; C08K 5/3492; C08J 3/22; C08K 5/00; C08K 5/06; C08L 77/02; C08K 5/52; C08K 3/38

(52) U.S. Cl. CPC C08K 3/32; C08K 5/5205; C08K 5/34924; C08K 3/38; C08K 5/0016; C08K 5/06; C08L 77/02; C08J 3/22; C08K 2003/387; C08J 2377/02; C08J 2461/28

(57) ABSTRACT

Disclosed herein is a novel flame retardant composition comprising aluminum phosphinate for thermoplastics such as polypropylene, copolymers of polypropylene, polyethylene, polyethylene terephthalates, polystyrene and/or other polymers or mixtures of polymers containing organic and/or inorganic fillers. The novel flame retardant composition may further comprise a plasticizer for obtaining improved processability as well as for obtaining a better flexibility and a lower energy consumption during the processing step.

### PRIORITIES AND CROSS REFERENCES

This application claims priority from U.S. Provisional Application No. 62/096,210 filed on 23 Dec. 2014, the teachings of which are hereby incorporated herein in their entirety.

### FIELD OF THE INVENTION

This invention relates to a novel flame retardant composition for thermoplastics and mixtures thereof. In one embodiment, the novel flame retardant composition is a novel flame retardant used to create a flame retarded thermoplastic composition.

### BACKGROUND

International Patent Publication No. WO 02/28953 to Steen-Bakkers-Menting et al. (“Steen-Bakkers-Menting”) discloses a halogen-free flame retarder composition for use in thermoplastic compositions. Steen-Bakkers-Menting discloses glass fibre-reinforced polyamide compositions containing a phosphinate compound according to formula (I) and/or formula (II), a polyphosphate salt of a 1,3,5-tri-azine compound according to formula (III) and an olefin copolymer. Steen-Bakkers-Menting discloses that formula (I) is:

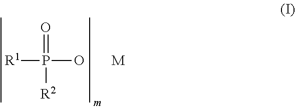

where R¹ and R² are hydrogen, a linear or branched C1-C6 alkyl radical, or a phenyl radical; M is an alkaline earth metal or alkali metal, Al, Zn, Fe, or a 1,3,5-triazine compound; and m is 1, 2 or 3. Accordingly, a compound according to formula (I) is an organic phosphinate having a single metal ion. Steen-Bakkers-Menting further discloses that formula (II) is:

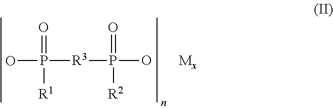

where R¹ and R² are hydrogen, a linear or branched C1-C6 alkyl radical, or a phenyl radical; R³ is a linear or branched C1-C10 alkylene, arylene, alkylarylene, or arylalkylene radical; M is an alkaline earth metal or alkali metal, Al, Zn, Fe, or a 1,3,5-triazine compound; n is 1 or 3; and x is 1 or 2. Accordingly, a compound according to formula (II) is also an organic phosphinate.

U.S. Pat. No. 7,608,654 to Costanzi et al. (“Costanzi”) discloses a halogen-free thermoplastic flame retardant composition comprising a hypophosphorous acid metal salt and an aromatic polycarbonate resin. As disclosed at column 2, lines 40 to 47, Costanzi is always to the use of aromatic polycarbonate resin, and Costanzi's working examples are based on Lexan 141 polycarbonate resin alone or in combination with PBB104 polycarbonate resin. Further, as disclosed in Tables 1, 2, and 3, Costanzi's working examples utilize calcium hypophosphite, aluminum hypophosphite, tripheny(l) phosphate, and combinations thereof. Finally, at column 3, lines 29 to 39, Costanzi explicitly states that there is no need to use nitrogen compounds such as melamine cyanurate, melamine polyphosphate, melamine borate, melamine pyrophosphate, ureaphosphate or similar products.

DP-111, available from JJI Technologies, Painesville Ohio, USA is an inorganic aluminum compound with at least two aluminum ions and phosphinate ions; wherein the ratio of the number of moles of aluminum ions to the number of moles of phosphinate ions in the at least one aluminum species is 1:3; at least one of the phosphinate ions bridges between the at least two aluminum ions. The simplest aluminum species has the structure comprising:

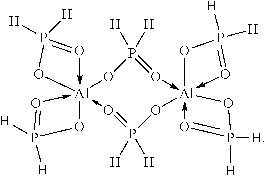

### SUMMARY

Disclosed herein is a flame retardant composition comprising at least one aluminum species wherein the at least one aluminum species comprises at least two Aluminum ions and at least two phosphinate ions; wherein the ratio of the number of moles of aluminum ions to the number of moles of phosphinate ions in the at least one aluminum species is 1:3; at least one of the phosphinate ions bridges between the at least two aluminum ions, melamine formaldehyde, and melamine polyphosphate.

In one embodiment, the at least one aluminum species comprises

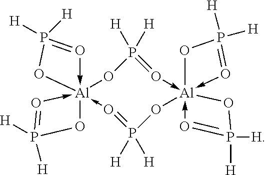

In one embodiment, the flame retardant composition further comprises melamine cyanurate. In a further embodiment, the flame retardant composition further comprises zinc borate.

In one embodiment, the flame retardant composition further comprises a plasticizer.

In one embodiment the plasticizer is a compound of the formula

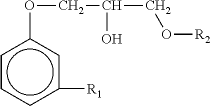

where R₁ is a 15 carbon atom aliphatic chain containing one, two or three non-conjugated double bonds and has the formula —[CH₂]₇—C₇H₁₀₋₁₄—CH₃ and R₂ is selected from the group consisting alkyls, and aryls optionally having one or more functional groups, and the oxygen is bonded to any carbon of R₂.

In one embodiment the plasticizer is a compound of the formula

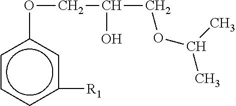

where R₁ is a 15 carbon atom aliphatic chain containing one, two or three non-conjugated double bonds and has the formula —[CH₂]₇—C₇H₁₀₋₁₄—CH₃.

In one embodiment of the flame retardant composition the at least one aluminum compound is present at a level in the range of 50 to 85% by weight of the flame retardant composition, the melamine formaldehyde is present at a level in the range of 10 to 20% by weight of the flame retardant composition, the melamine polyphosphate is present at a level in the range of 2 to 17% by weight of the flame retardant composition, the plasticizer is present at a level in the range of 0.1 to 3% by weight of the flame retardant composition, and all of the components of the flame retardant composition add up to 100% by weight of the flame retardant composition.

Also disclosed herein is a flame retarded composition comprising a flame retardant composition and a thermoplastic. In one embodiment the thermoplastic is selected from the group consisting of polybutylene terephthalate, polyethylene terephthalate, and polyamide. In one embodiment the thermoplastic is polyamide nylon 6,6. Other suitable polymers are the olefins such polypropylene and polyethylene.

In one embodiment of the flame retarded composition the flame retardant composition is present in the composition at a level in the range of between 10 and 30% by weight of the flame retarded composition, the thermoplastic is present in the composition at a level in the range of between 40 and 90% by weight of the flame retarded composition, and all of the components of the flame retarded composition add up to 100% by weight of the total weight of the flame retarded composition.

One embodiment of the flame retarded composition further comprises a filler such as a glass filler which may be present at levels from 5-50% by weight of the total composition.

### DETAILED DESCRIPTION

Disclosed in this specification is a new flame retardant composition that can be used in a flame retarded composition comprising the flame retardant composition and thermosets, thermoplastics, thermoplastic polymer matrices, copolymers, terpolymers, coatings, paints, films, and resins binders. The flame retarded composition may be present as an article formed from the flame retarded composition such as a fiber or injection molded article.

The inventors surprisingly found that an improved flame retardant composition comprising an inorganic aluminum phosphinate and a nitrogen containing compound such as melamine formaldehyde and/or melamine polyphosphate improves the flame retardant performance of the inorganic aluminum phosphinate and can be used to make a flame retarded composition using several different thermoplastics, including polyamides and polyesters.

The first component of the flame retardant composition is an inorganic aluminum phosphinate having at least two aluminum ions. One example of such a compound has the CAS chemical number 321142 and the CAS chemical name Aluminum, bis[μ-(phosphinate-κO:κO′)]tetrakis(phosphinate-κO)di-, and is commercially available as DP-111, from JJI Technologies, Painesville, Ohio, USA. DP-111 is an inorganic aluminum phosphinate having at least two aluminum ions and phosphinate ions; wherein the ratio of the number of moles of aluminum ions to the number of moles of phosphinate ions is 1:3, and at least one of the phosphinate ions bridges between the at least two aluminum ions. The simplest inorganic aluminum phosphinate species has the structure comprising:

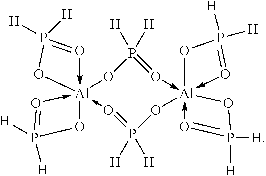

The experimental data shows that the DP-111 inorganic aluminum phosphinate catches fire when exposed to a flame and is classified as a flammable solid per UN Class 4, Division 4.1 UN rating test for transportation. The DP-111 inorganic aluminum phosphinate was unable to be processed in glass-filled nylon 6,6 without discoloration and the final product exhibited very poor extrudate form, degradation of polymer, poor physical properties and high shear ratings causing flare-ups and flames during the extrusion process. The processing window was very narrow and the end compounded product was deemed unacceptable.

In order to improve the flame retardant composition, additional additives were included. Such additives include either melamine formaldehyde (e.g. MF829 available from Tembec BTLSR, Toledo, Ohio, United States), melamine polyphosphate (e.g. Melapur 200 available from BASF Corporation, Florham Park, N.J., United States), or both.

The flame retardant composition may be further mixed with zinc borate. The amount of zinc borate may be up to 20 weight percent of the total composition with up to weight percent of zinc borate in the total composition being preferred. The composition may also contain melamine cyanurate. The amount of melamine cyanurate may be up to 20 weight percent of the total composition.

### Example I

The flame retardant components of the flame retardant composition were tested as follows:

TABLE 1
Flame Retardant Composition

| | Wt % DP-111 | Wt % | Wt % | |
|---|---|---|---|---|
| Run | (Aluminum | Melamine- | Melamine | |
| No. | Species) | Formaldehyde | Polyphosphate | TGA |
| Ctrl | 100 | 0 | 0 | 290 |
| 1 | 80 | 10 | 10 | 305 |
| 2 | 90 | 5 | 5 | 298 |
| 3 | 75 | 15 | 10 | 311 |
| 4 | 70 | 20 | 10 | 309 |
| 5 | 85 | 15 | 0 | 307 |
| 6 | 90 | 0 | 10 | 315 |

These compositions were made with micronized components. Run 5 had a slightly lower TGA (307° C.) than the others. Run No. 3 had the best TGA/flammability balance.

The flame retardant composition demonstrates flame retardant properties in that it does not catch fire when exposed to a flame and has been classified as a non-flammable solid via UN Class 4 division 4.1 flammable solid testing for transportation. However, when blended with thermoplastics, such as polyamide nylon 6,6, the resulting composition surprisingly showed visible spontaneous combustion in an extruder or injection molding machine due to high shear, increased temperatures and multiple heat cycles.

Surprisingly, when the inventors included a plasticizer, such as those disclosed in U.S. Pat. No. 8,349,924, the teachings of which are hereby incorporated by reference in their entirety, the flame retardant composition did not spontaneously combust when blended with a thermoplastic such as polyamide nylon 6,6 and extrudate was free of polymer discoloration and degradation while displaying positive physical properties.

As described in U.S. Pat. No. 8,349,924, the preferred plasticizer is an isopropyl adduct of an epoxidized Cardanol derivative. Cardanol oil is the extracted oil from the cashew nutshell. Cardanol is used to describe the decarboxylated derivatives made from the thermal decomposition of any of the naturally anacardic acids. This includes more than one compound because the composition of the side chain, R, varies in its degree of unsaturation. Tri unsaturated cardanol is the major component and is usually present at about 41%. The remaining cardanol is about 34% mono-unsaturated with 22% bi-unsaturated, and 2% saturated.

As described in U.S. Pat. No. 8,349,924, in the general sense, an epoxidized cardanol derivative is:

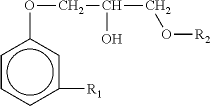

where R₁ is a 15 carbon atom aliphatic chain containing one, two or three non-conjugated double bonds and has the formula [CH₂]₇—C₇H₁₀₋₁₄—CH₃, and R₂ is selected from the group consisting of alkyls and aryls, or mixtures thereof with or without one or more functional groups. The bond of the oxygen to the carbon of R₂ may be any carbon of the R₂ species. One preferred epoxidized cardanol is an adduct of epoxidized cardanol (Cardolite® NC-513) with an amine.

As described in U.S. Pat. No. 8,349,924, when reacted (derivatized) with isopropyl alcohol, the structure is as shown below:

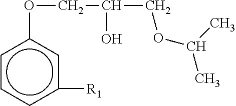

In this compound, R₁ is a 15 carbon atom aliphatic chain containing one, two or three non-conjugated double bonds and has the formula —[CH₂]₇—C₇H₁₀₋₁₄—CH₃. This compound's chemical name is 2-propanol, 1-(1-methylethoxy)-, 3-(cashew nutshell liq. oxy) derivs. This epoxidized cardanol derivatized with isopropyl alcohol is one preferred plasticizer.

The alcohol reacted with the epoxidized cardanol to create the derivatized epoxidized cardanol can be selected from the group consisting of aliphatic or substituted alcohols with one or more functional groups in addition to the hydroxyl group, alkyl alcohols with one or more functional groups in addition to the hydroxyl group, and aryls with the one or more functional groups in addition to the hydroxyl group. The alcohol may also be selected from the group consisting of methanol, ethanol, propanol isomers, and butanol isomers.

A preferred flame retardant composition comprises: 3.75 lbs (1703 gms) (73% by weight of the flame retardant composition) of the Aluminum Phosphinate (DP-111), 14 gms (0.6% by weight of the flame retardant composition) of the epoxidized cardanol derivatized with isopropyl alcohol, 0.75 lbs (341 gms) (14.6% by weight of the flame retardant composition) of melamine formaldehyde, and 0.50 lbs (277 gms) (11.8% by weight of the flame retardant composition) of melamine polyphosphate. Wherein all the components of the flame retardant composition comprise 100% by weight of the composition.

Calcium stearate may also be present in amount of up to 1 weight percent of the flame retardant composition. Calcium stearate in an amount of up to 1 weight percent is preferred when the flame retarded composition contains thermoplastic polyamides such as nylon 6,6. In applications where the flame retarded composition contains polybutylene terephthalate a fatty ester in an amount of up to 1 weight percent is preferred instead of calcium stearate as the fatty esters are known to have greater compatibility with polybutylene terephthalate.

The preferred ranges of the components comprising the flame retardant composition are 50 to 85% (by weight of the flame retardant composition) of the aluminum compound having two aluminum ions exemplified by the DP-111 aluminum phosphinate, 0.1 to 3% (by weight of the flame retardant composition) of the plasticizer exemplified by the isopropyl adduct of an epoxidized cardanol derivative, 10 to 20% (by weight of the flame retardant composition) of the melamine formaldehyde, and 2 to 17% (by weight of the flame retardant composition) of the melamine polyphosphate, wherein all the components of the flame retardant composition add up to 100% by weight of the composition.

Preferably the flame retardant composition is substantially free of halogens with a flame retardant composition that is completely halogen free being more preferred.

The components of the flame retardant composition are combined in a vessel and mixed. Preferably, the mixing occurs in a high intensity mixer, such as a Henschel mixer. Mixing preferably occurs for a time in the range of between 5 minutes and 60 minutes with a time in the range of between 5 minutes and 45 minutes being more preferred and a time in the range of between 10 minutes and 30 minutes being most preferred.

This flame retardant composition can be added to thermosets, thermoplastics, thermoplastic polymer matrices, copolymers, terpolymers, coatings, paints, films, and resin binders to create a flame retarded composition. The flame retarded composition may be present as an article formed from the flame retarded composition such as a fiber or injection molded article or an extruded article.

Examples of the thermoplastics useful in the flame retarded composition are the polyamides, such as nylon 6 and nylon 6,6, polyesters such as polybutylene terephthalate and polyethylene terephthalate; the polycarbonates; and the polyolefins such as polypropylene and polyethylene. PVC, or polyvinyl choride polymers also benefit from the flame retardant composition. It has also been found that thermoplastic urethane compounds benefit from the flame retardant composition. In particular, it has been found that in cold cast polyurethane products, as little as 5% by weight of the flame retardant composition can eliminate flammable dripping of the polyurethane resin.

When used to create a flame retarded composition, the flame retardant composition is present in the range of 10 to 30 weight percent of the flame retarded composition with the thermoset, thermoplastic, thermoplastic polymer matrix, copolymer, terpolymer, coating, paint, film or resin binder component(s) ranging from 40 to 90 weight percent of the flame retarded composition with the weight of all the components of the flame retarded composition totaling 100 weight percent. Components other than a thermoset, thermoplastic, thermoplastic polymer matrix, copolymer, terpolymer, coating, paint, film or resin binder and the flame retardant composition are contemplated so long as the total amount of all the components total 100 weight percent of the flame retarded composition.

The flame retarded composition may also include a filler. The filler may be an organic filler or an inorganic filler. One such filler is a glass filler. When used, the glass filler may be present in the range of 5 to 50 weight percent of the flame retarded composition.

Preferably the flame retarded composition is substantially free of halogens with a flame retarded composition that is completely halogen free being more preferred.

In one embodiment, the flame retardant composition may be added to the flame retarded composition as a masterbatch. When added as a masterbatch, the flame retardant composition comprising the at least one aluminum species, melamine formaldehyde, melamine polyphosphate, and optionally melamine cyanurate, zinc borate and/or a plasticizer is blended in a thermoplastic. The thermoplastic used for the masterbatch may be any of the thermoplastics used for the flame retarded composition. Preferably, the thermoplastic used for the masterbatch is the same thermoplastic used for the flame retarded composition. When added as a masterbatch it is preferred that the flame retardant is present in the masterbatch in a range selected from group consisting of 25 to 75 percent by weight of the masterbatch, 30 to 70 percent by weight of the masterbatch, 35 to 65 percent by weight of the masterbatch, 40 to 60 percent by weight of the masterbatch, and 45 to 55 percent by weight of the masterbatch.

### Example II

One preferred embodiment of the flame retarded composition was prepared on a Prism TSE-16-TC 16 mm twin screw extruder. The composition comprises 50% by weight of polyamide nylon 6,6; 20% by weight of the flame retardant composition comprising 74% by weight DP-111, 10% by weight melamine polyphosphate (Melapur 200 by BASF), 15% by weight melamine formaldehyde resin (MF829 by Tembec BTLSR Inc.), 0.5% by weight calcium stearate, and 0.5% by weight of cardanol based alkyl phosphate plasticizer (Jemini 100 available from JJI Technologies, LLC, Painesville, Ohio, USA); and 30% by weight of EC10 701LS glass fibers available from Johns Mansville, Medina, Ohio, United States. The flame retardant composition was produced by blending the components in a Henschel blender, and was added to the preferred flame retarded composition as a powder. This preferred flame retarded composition was compared to a control composition containing 50% by weight of polyamide nylon 6,6, 20% by weight of a commercially available flame retardant composition known as Exolit OP1312 manufactured by Clariant Additives GMBH, Muttenz, Switzerland, and 30% by weight of EC10 701LS glass fibers. Following extrusion, the compositions were injection molded to produce ASTM tensile and flame bars for physical testing comparisons. The results of this comparison are summarized in Table 2 below.

TABLE 2
Comparison of Improved Flame Retardant
Composition with Clariant Exolit OP1312

| | Clariant Exolit | Improved Flame |
|---|---|---|
| | OP1312 | Retardant |
| | (Control) | (Experimental) |
| Extruder RPM | 518 | 520 |
| Extruder Torque Range | 17 to 20 | 14.2 to 17.4 |
| Extruder Torque Load (%) | 75 to 80 | 60 |
| Extruder Melt Temperature (° C.) | 279 | 274 |
| Extruder Head Pressure | 230 to 330 | 140 to 225 |
| Density (g/cc) | 1.15 | 1.14 |
| Tensile Strength at Max Load | 127.3 | 153.7 |
| 5 mm/min (MPa) | | |
| Elongation at breaking (%) | 2.35 | 1.76 |
| Tensile Modulus at 5 mm/min | 10785 | 11590 |
| (MPa) | | |
| Stress at Flex Yield | 204.4 | 239.9 |
| Maximum at 1.3 mm/min (MPa) | | |
| Tangent Modulus | 10049.5 | 10458.6 |
| 1% Secant Modulus (MPa) | 10169.8 | 10998.7 |
| Izod Impact - Unotched | 9.80 | 7.64 |
| (ft · lb · in) | | |
| HDT at 1.8 MPa, C. | 245 | 241 |
| Flammability | UL 94 V-0 | UL 94 V-0 |
| | (1.6 mm) PASS | (1.6 mm) PASS |
| | UL 94 V-0 | UL 94 V-0 |
| | (.8 mm) PASS | (.8 mm) PASS |

As can be seen above, the improved flame retardant exhibited a 23% drop in torque produced and a 64% drop in head pressure as compared to the control. Additionally, there was a 5° C. drop in melt temperature when processing the composition including the improved flame retardant. In general, the improved flame retardant composition preserves more of the physical properties (tensile strength, tensile modulus, tangent modulus, etc.) of the nylon 6,6 resin in the glass-filled formulation while providing identical flame performance properties using UL94V-0 testing.

We claim:

1. A flame retardant composition comprising:
at least one aluminum species wherein the at least one aluminum species comprises at least two Aluminum ions and at least two phosphinate ions; wherein the ratio of the number of moles of aluminum ions to the number of moles of phosphinate ions in the at least one aluminum species is 1:3, and at least one of the phosphinate ions bridges between the at least two aluminum ions,
melamine formaldehyde, and
melamine polyphosphate.

2. The flame retardant composition of claim 1, wherein the at least one aluminum species comprises:

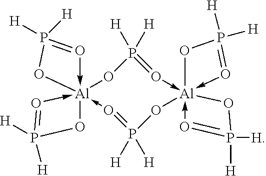

3. The flame retardant composition of claim 2, further comprising melamine cyanurate.

4. The flame retardant composition of claim 3, further comprising zinc borate.

5. The flame retardant composition of claim 4, further comprising a plasticizer.

6. The flame retardant composition of claim 5, wherein the plasticizer is a compound of the formula: 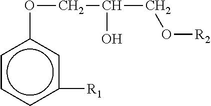
where R₁ is a 15 carbon atom aliphatic chain containing one, two or three non-conjugated double bonds and has the formula —[CH₂]₇—C₇H₁₀₋₁₄—CH₃, and R₂ is selected from the group consisting alkyls and aryls optionally having one or more functional groups, and the oxygen is bonded to any carbon of R₂.

7. The flame retardant composition of claim 5, wherein the plasticizer has the formula: 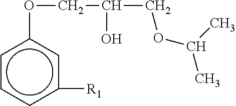
where R₁ is a 15 carbon atom aliphatic chain containing one, two or three non-conjugated double bonds and has the formula —[CH₂]₇—C₇H₁₀₋₁₄—CH₃.

8. The flame retardant composition of claim 6, wherein
the at least one aluminum compound is present at a level in the range of 50 to 85% by weight of the flame retardant composition,
the melamine formaldehyde is present at a level in the range of 10 to 20% by weight of the flame retardant composition,
the melamine polyphosphate is present at a level in the range of 2 to 17% by weight of the flame retardant composition,
the plasticizer is present at a level in the range of 0.1 to 3% by weight of the flame retardant composition, and
all of the components of the flame retardant composition add up to 100% by weight of the flame retardant composition.

9. The flame retardant composition of claim 7, wherein
the at least one aluminum compound is present at a level in the range of 50 to 85% by weight of the flame retardant composition,
the melamine formaldehyde is present at a level in the range of 10 to 20% by weight of the flame retardant composition,
the melamine polyphosphate is present at a level in the range of 2 to 17% by weight of the flame retardant composition,
the plasticizer is present at a level in the range of 0.1 to 3% by weight of the flame retardant composition, and
all of the components of the flame retardant composition add up to 100% by weight of the flame retardant composition.

10. The flame retardant composition of claim 1, wherein the flame retardant composition is substantially halogen free.

11. A flame retarded composition comprising the flame retardant composition of claim 1, and a thermoplastic.

12. A flame retarded composition comprising the flame retardant composition of claim 8, and a thermoplastic.

13. A flame retarded composition comprising the flame retardant composition of claim 9, and a thermoplastic.

14. The flame retarded composition of claim 11, wherein the thermoplastic is selected from the group consisting of polybutylene terephthalate, polyethylene terephthalate, and the polyamides.

15. The flame retarded composition of claim 12, wherein the thermoplastic is selected from the group consisting of polybutylene terephthalate, polyethylene terephthalate, and the polyamides.

16. The flame retarded composition of claim 13, wherein the thermoplastic is selected from the group consisting of polybutylene terephthalate, polyethylene terephthalate, and the polyamides.

17. The flame retarded composition of claim 11, wherein
the flame retardant composition is present in the flame retarded composition at a level in the range of between 10 and 30% by weight of the flame retarded composition,
the thermoplastic is present in the flame retarded composition at a level in the range of between 40 and 90% by weight of the flame retarded composition, and
all of the components of the flame retarded composition add up to 100% by weight of the total weight of the flame retarded composition.

18. The flame retarded composition of claim 11, further comprising a glass filler.

19. The flame retarded composition of claim 11, wherein the flame retardant composition is added to the flame retarded composition as a masterbatch comprising the flame retardant composition and a masterbatch thermoplastic.

20. The flame retarded composition of claim 19, wherein the masterbatch thermoplastic is same as the thermoplastic of the flame retarded composition.

21. The flame retarded composition of claim 20, wherein the flame retardant composition is present in the masterbatch at a level in a range selected from the group consisting of 25 to 75 percent by weight of the masterbatch, 30 to 70 percent by weight of the masterbatch, 35 to 65 percent by weight of the masterbatch, 40 to 60 percent by weight of the masterbatch, and 45 to 55 percent by weight of the masterbatch.
